(19) United States
(12) Patent Application Publication
(10) Pub. No.: US 2001/0020903 A1
(43) Pub. Date: Sep. 13, 2001

(54) Portable hazard-warning device

(76) Inventor: Shiunn Terny Wang, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/834,612

(22) Filed: Apr. 16, 2001

Related U.S. Application Data
(63) Continuation-in-part of application No. 09/382,793, filed on Aug. 25, 1999, now abandoned.

(51) Int. Cl. G08B 23/00

(52) U.S. Cl. 340/908; 340/907

(57) ABSTRACT

A hazard-warning device includes a shank portion with lights and batteries received therein and a flashlight head is pivotally connected to a neck portion which is rotatably connected to the shank portion and two buttons are respectively attached to the shank portion to control the flashlight head and the lights. A sleeve is slidably mounted to the shank portion and three legs are respectively and pivotally connected to the sleeve and three expanding rods are respectively and pivotally connected between the legs and the shank portion.

### FIELD OF THE INVENTION

The present invention is a continuation-in-part application to applicant's patent application Ser. No. 09/382,793, filed on Aug. 25, 1999.

### BACKGROUND OF THE INVENTION

A warning device known to the applicant is disclosed in the U.S. Pat. No. 4,922,223 to Prevot, entitled as “Emergency Identifier For Vehicles” issued on May 1, 1990. The emergency identifier occupies a large volume and involves a complicated structure, so that the device cannot be used conveniently. In other words, the emergency identifier will occupy most of the space of the trunk of the vehicle. U.S. Pat. No. 5,684,452 with a title of “Multi-Purposes Warning Device”, filed on Jun. 12, 1995 has three feet that can be expanded to form a stable stand and a light that is connected to the device and can be pivoted.

The present invention intends to provide a portable hazard-warning device which has a compact size and a plurality of functions which are able to be used in different situations.

### SUMMARY OF THE INVENTION

In accordance with one aspect of the present invention, there is provided a hazard-warning device and comprising a shank portion having lights received therein and a flange extending radially outward therefrom. A neck portion is rotatably connected to the first end of the shank portion and a flashlight head is pivotally connected to the neck portion. Two buttons are respectively attached to the shank portion to control the flashlight head and the lights.

A sleeve is slidably mounted to the shank portion and limited between the flashlight head and the flange. Three legs each have the first end thereof pivotally connected to the sleeve and three expanding rods are respectively and pivotally connected between the legs and the second end of the shank portion.

A first cap is threadedly connected to the second end of the shank portion and a second cap is attached to the three legs and sized to receive the respective three second ends of the three legs.

The main object of the present invention is to provide a portable hazard-warning device which can be used as a triangle frame, a flashlight and a light emitting warning device.

Another object of the warning device provides light received in the transparent shank portion thereof so that it can be seen from a far distance when standing on the road and provides sufficient time for reaction for the vehicles followed behind.

Further objects, advantages, and features of the present invention will become apparent from the following detailed description with appropriate reference to the accompanying drawings.

### BRIEF DESCRIPTION OF THE DRAWINGS

FIG. 1 is an exploded view of the warning device in accordance with the present invention;

FIG. 2 is a side elevational view, partly in section, of the warning device in accordance with the present invention, wherein the three legs are retracted toward the shank portion;

FIG. 3 is an illustrative view to illustrate the engagement between the neck portion and the flashlight head, and

FIG. 4 is a side elevational view, partly in section, of the warning device in accordance with the present invention, wherein the three legs are expanded outwardly to form a triangle.

### DETAILED DESCRIPTION OF THE PREFERRED EMBODIMENT

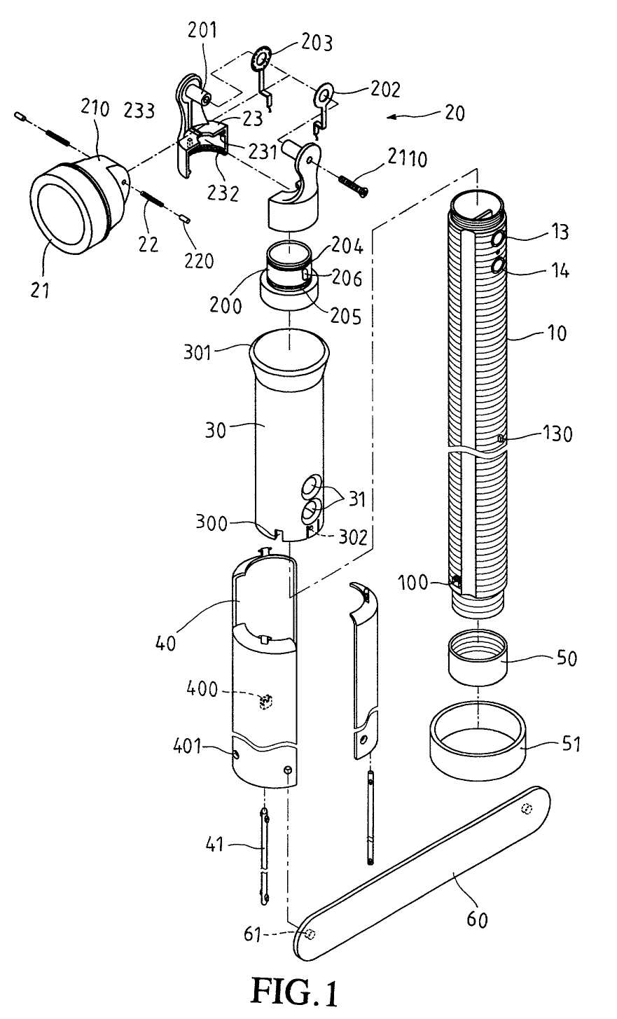

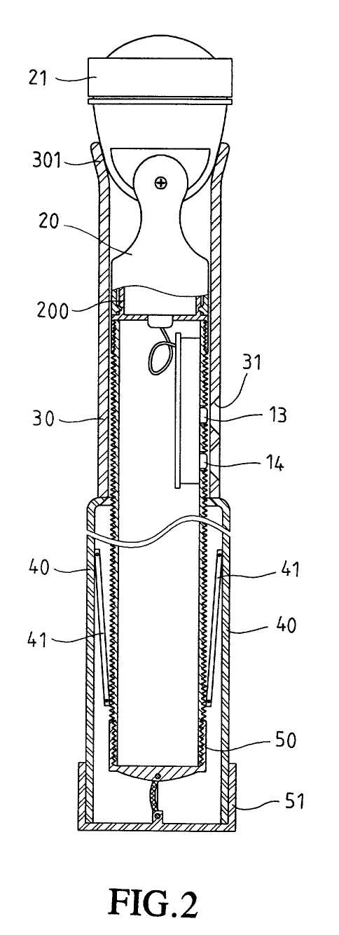

Please referring to FIGS. 1 and 2, the hazard-warning device in accordance -with the present invention comprises a transparent shank portion 10 in which lights and batteries are received so as to perform a light device. A flange 130 extends radially outward therefrom and a first button 13 and a second button 14 are respectively attached to the shank portion 10. A sleeve 30 is movably mounted to the shank portion 10 and a boss 302 extends from an inner periphery of the sleeve 30 so that the boss 302 is stopped by the flange 130 on the shank portion 10 to prevent the sleeve 30 from dropping from the shank portion 10. The sleeve 30 has two holes 31 defined therethrough from which the first button 13 and the second button 14 are accessed.

A base 200 is received in the sleeve 30 and is fixedly connected to a first end of shank portion 10. The base 200 has two annular grooves 204, 205 defined in an outer periphery thereof and a neck portion 20 is rotatably connected to the base 200. The neck portion 20 has a skirt portion 23 for receiving the base 200 therein and two flanges 231, 232 extend from an inner periphery of the skirt portion 23 so as to be respectively engaged with the two annular grooves 204, 205. A first rib 233 extends radially inward from the skirt portion 23 and the base 200 has a second rib 206 extending radially outward from the base 200 so that the neck portion 20 is rotatable relative to the base 200 and limited when the first rib 233 contacts the second rib 206. A flashlight head 21 is pivotally connected to the neck portion 20 and controlled by the buttons 13, 14. The sleeve 30 has an enlarged end 301 which receives the flashlight head 21. The neck portion 20 has two tubes 201 extending inwardly therefrom and the flashlight head 21 has a tongue 210 extending therefrom which has a hole 211 to receive the two tubes 201 and a bolt 2110 connects the tongue 210 and the two tubes 201.

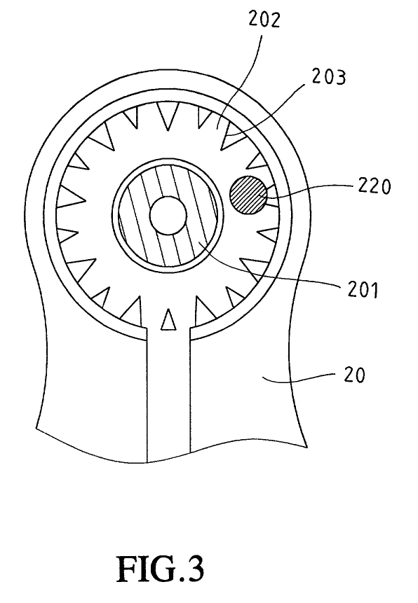

Further referring to FIG. 3, two ring members 202 are respectively mounted to the two tubes 201 and each of the ring members 202 has a serrated inner surface 203 and the tongue 210 further has two apertures 212 on two sides thereof. Each of the apertures 212 has a spring 22 and a pin 220 received therein so that the pins 220 contact the serrated inner surfaces 203 of the two ring members 202 so as to provide a closed circuit if the first button 13 is pushed. The flashlight head 21 can be rotated 360 degrees about the base 200.

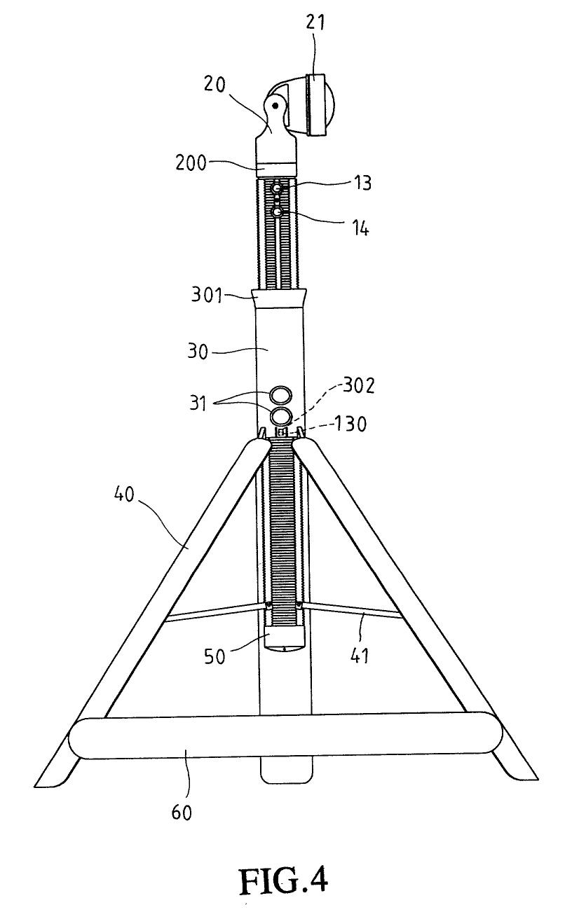

Further referring to FIGS. 2 and 4, three legs 40 each have a first end pivotally connected to notches 300 defined in the sleeve 30 and three expanding rods 41 are respectively and pivotally connected between lugs 400 in the legs 40 and lugs 100 on a second end of the shank portion 10. A transverse plate 60 has stubs 61 on two ends thereof and each of the three respective second ends of the three legs 40 has a hole 401 for receiving the stubs 61 as shown in FIG. 4.

A first cap 50 is threadedly connected to the second end of the shank portion 10 to position the batteries in the shank portion 10 and a second cap 51 is bused to receive the respective second ends of the three legs 40 when the three legs 40 are not expanded.

The invention is not limited to the above embodiment but various modification thereof may be made. It will be understood by those skilled in the art that various changes in form and detail may made without departing from the scope of the present invention.

What is claimed is:

1. A hazard-warning device comprising:
a shank portion having a flange extending radially outward therefrom and a sleeve movably mounted to said shank portion and limited by said flange, a first button and a second button respectively attached to said shank portion;
a base received in said sleeve and fixedly connected to a first end of shank portion, said base having two annular grooves defined in an outer periphery thereof, a neck portion rotatably connected to said base and having two flanges which are engaged with said two annular grooves, a flashlight head pivotally connected to said neck portion and controlled by said buttons;
three legs each having a first end pivotally connected to said sleeve and three expanding rods respectively and pivotally connected between said legs and a second end of said shank portion, and
a first cap threadedly connected to said second end of said shank portion and a second cap receiving said respective second ends of said three legs when said three legs is not expanded.

2. The device as claimed in claim 1 further comprising a transverse plate having stubs on two ends thereof and each of said three respective second ends of said three legs having a hole for receiving said stubs.

3. The device as claimed in claim 1, wherein said sleeve has two holes defined therethrough from which said first button and said second button are accessed.

4. The device as claimed in claim 1, wherein said sleeve has an enlarged end which receives said flashlight head.

5. The device as claimed in claim 1, wherein said neck portion has two tubes extending inwardly therefrom and said flashlight head has a tongue extending therefrom which has a hole to receive said two tubes.

6. The device as claimed in claim 1, wherein said neck portion has a skirt portion in which said base is received, a first rib extending radially inward therefrom, said base having a second rib extending radially outward from said base so that the neck portion is limited when said first rib contacts said second rib.

7. The device as claimed in claim 1, wherein said sleeve has a boss extending from an inner periphery thereof and said boss is stopped by said flange on said shank portion.
